(19) United States
(12) Patent Application Publication
(10) Pub. No.: US 2017/0222799 A1
(43) Pub. Date: Aug. 3, 2017

(54) LOCATION BASED ACCESS FOR KEY RETRIEVAL

(71) Applicant: Cocoon Data Holdings Pty Limited, Sydney (AU)

(72) Inventor: Trent David Telford, Alpine (AU)

(21) Appl. No.: 15/421,439

(22) Filed: Feb. 1, 2017

(30) Foreign Application Priority Data
Feb. 3, 2016 (AU) 2016900349

(51) Int. Cl. H04L 9/08; H04L 9/32

(52) U.S. Cl. CPC H04L 9/083; H04L 9/32

(57) ABSTRACT

A method for key retrieval. The method comprises receiving, from a device, a request to access a key associated with an encrypted data object; identifying at least one policy associated with the key, the policy including requirements for a geographic origin of the request; receiving a signed location of the device, the location being signed using a private key associated with the device; and verifying the signed location using a public key associated with the device. The method further comprises determining if the verified location satisfies the requirements for a geographic origin; and if the location satisfies the requirements for a geographic origin, providing the key to the device.

### REFERENCE TO RELATED PATENT APPLICATION(S)

This application claims the benefit under 35 U.S.C. §119 of the filing date of Australian Patent Application No. 2016900349, filed 3 Feb. 2016, hereby incorporated by reference in its entirety as if fully set forth herein.

### TECHNICAL FIELD

The present invention relates generally to encryption of data and, in particular, to a system and method for regulated distribution of keys for decrypting data.

### BACKGROUND

Data security is a major issue across geographic boundaries. For example, data sovereignty is an issue for many organisations as privacy laws often vary from country to country. Some organisations may choose to make personnel data available only in certain jurisdictions due to specific privacy laws and regulatory requirements of that jurisdiction.

In order to limit access to data to geographic areas, such as a particular country or jurisdiction, a person requesting data needs to be supplied with a key in order to decrypt that data. Access to the key may be restricted based on their geographic location, such that the requestor is required to provide their current location. However data, such as location data, can easily be artificially created. Data systems intended to limit data availability to certain countries or geographic areas can be prone to fraud.

### SUMMARY

It is an object of the present invention to substantially overcome, or at least ameliorate, one or more disadvantages of existing arrangements

According to a first aspect of the present disclosure, there is provided a method for key retrieval comprising: receiving, from a device, a request to access a key associated with an encrypted data object; identifying at least one policy associated with the key, the policy including requirements for a geographic origin of the request; receiving a signed location of the device, the location being signed using a private key associated with the device; verifying the signed location using a public key associated with the device; determining if the verified location satisfies the requirements for a geographic origin; and if the location satisfies the requirements for a geographic origin, providing the key to the device.

Another aspect of the present disclosure provides a server computer, comprising: a processor; a memory coupled to the processor, the memory storing an application configured to perform a method for key distribution comprising: receiving, from a device via a network, a request to access a key associated with an encrypted data object; identifying at least one policy associated with the key, the policy including requirements for a geographic origin of the request; receiving a signed location of the device from the device via the network, the location being signed using a private key associated with the device; verifying the signed location using a public key associated with the device; determining if the verified location satisfies the requirements for a geographic origin; and if the location satisfies the requirements for a geographic origin, providing the key to the device via the network.

A further aspect of the present disclosure provides an electronic device, comprising: a processor; one or more user inputs; a display; and a memory coupled to the processor, the memory storing a private key associated with the electronic device and an application, the application comprising instructions executable on the processor to perform a method of key distribution comprising: receiving, via the user inputs, instructions to request to access a key associated with an encrypted data object; transmitting a request to a server computer via a network to access the key; determining a geographic location of the electronic device; signing the determined geographic location using the private key; transmitting the signed geographic location to the server computer; receiving a reply from the server computer via the network; and if the received reply includes the requested key; decrypting the data object using the key, otherwise providing an error message on the display.

Another aspect of the present disclosure provides an application executable on a processor of an electronic device, the application comprising instructions to case the electronic device to at least: receiving, via user inputs of the electronic device, instructions to request to access a key associated with an encrypted data object; transmit a request to a server computer via a network to access the key; determine a geographic location of the personal computing device; sign the determined geographic location using the private key; transmit the signed geographic location to the server computer; receive a reply from the server computer via the network; and if the received reply includes the requested key; decrypt the data object using the key, otherwise display an error message.

Other aspects are also disclosed.

### BRIEF DESCRIPTION OF THE DRAWINGS

At least one embodiment of the present invention will now be described with reference to the drawings and appendices, in which:

FIG. 1A shows a system for regulated key retrieval.

FIG. 1B forms a schematic block diagram of a device upon which arrangements described can be practiced in the system of FIG. 1A;

FIGS. 2A and 2B show an example database structure stored for a regulated key retrieval service;

FIG. 3 shows data flow operations of a method for regulated key retrieval;

FIG. 4 shows the method for regulated key retrieval from a point a view of a client device; and

FIG. 5 shows the method for regulated key retrieval from a point a view of a server.

### DETAILED DESCRIPTION INCLUDING BEST MODE

### Overview

The arrangements described relate to a key service that provides keys. The keys can be used to encrypt and decrypt data. Encrypted data can then be transferred and shared between various users and/or systems. To access encrypted data, the key that encrypted the data is required. The key can be accessed by one or more users, other than the owner of the key. The arrangements described assume that the key service encrypts the key with the public key of each identity that has access to the key. Further, the owner of the key is able to specify an additional set of policies that must be successfully evaluated before the key (for the encrypted data) is released.

Australian Patent Publication No. AU 2013200771 A1 describes an example of a system by which secure object communications can be facilitated by way of a web-browser executing upon a user computing device and with which communications via a secure server can be performed. According to the arrangements of Australian Patent Publication No. 2013200771 A1, a data object is encrypted and a corresponding key is stored on a server of a secure communications service.

The creator of the encrypted data object sends the encrypted data object to a recipient. The recipient then requires the associated key to decrypt the data object.

In many cases, the creator wants to limit the geographic location in which the data may be accessed, regardless of the physical location of an individual recipient. Organisations are often subject to increasingly stringent requirements for data sovereignty. Some approaches apply geographic limits to where data may be accessed, such as the recipient providing a current geographic location and only being provided access to data if the current location is within a specified (or permitted) geographic area. However, provision of a geographic location may be easily subject to fraud, and may not be reliable. Further, an identity of the person trying to access data can also be easily fraudulently disguised.

The arrangements described relate to control of access to a key for decrypting data based upon an access policy including requirements for geographic origin of the request (rather than control of or access to data). The arrangements described provide a means by which greater trust can be established regarding a device requesting a decryption key and a geographic location of the device.

The arrangements described are based on keys being managed by a server. Before a key is provided to a user a number of access controls are checked at the server, including the geographic location of the user. Only when the user can be confirmed to be within a defined area is the key released to the user.

The geographic requirements described herein preferably relate to one or more geo-fences. A geo-fence establishes a spatial boundary within which a key can be released. If the recipient of the encrypted data makes a key request from within the spatial boundary, the requirements for geographic origin of the access policy are satisfied. If the recipient of the encrypted data falls outside the spatial boundary at the time of key request, the geographic requirements of access policy are not satisfied.

### System Structure

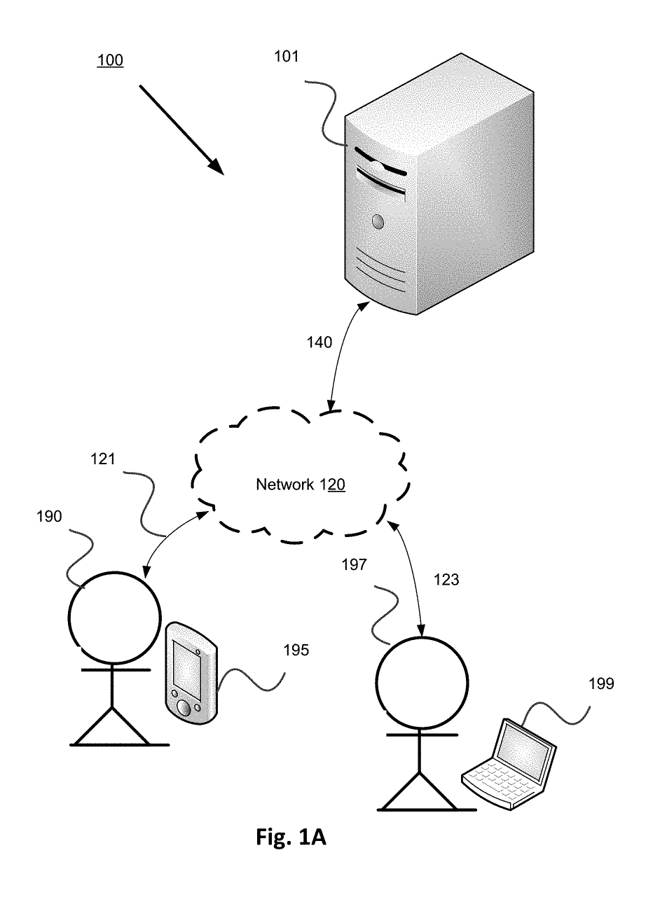

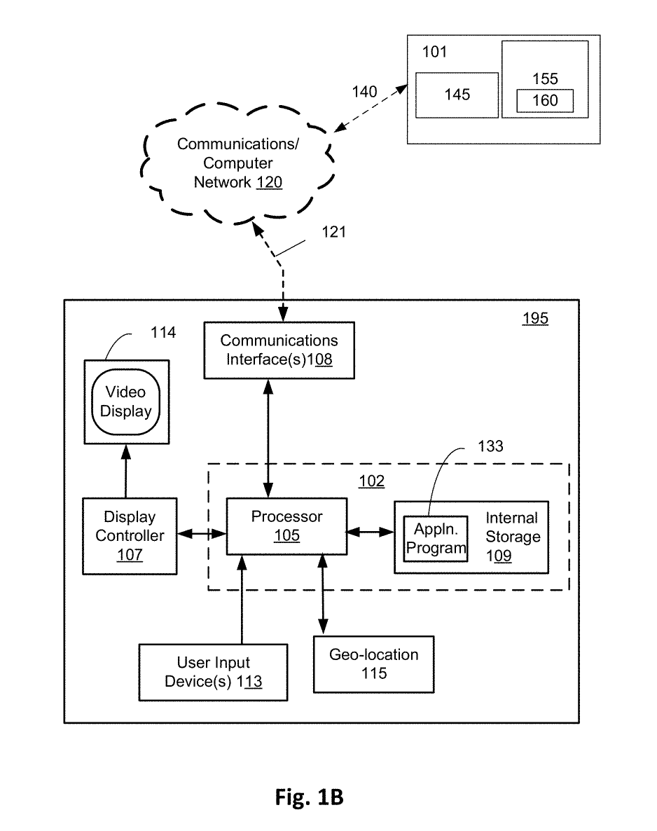

FIG. 1A shows a system 100 upon which the arrangements described may be practiced. In the system 100, a person 190 is owner and operator of an electronic device 195. In the example of FIG. 1A, the device 195 is a mobile communications device, such as a smartphone, tablet device or notebook computer. However, the device 195 may be any personal computing device capable of communicating over a network and determining the device's own geographic location. Similarly, another person 197 is an owner and operator of an electronic device 199, functionally similar to the device 195. The device 199 in the example of FIG. 1A is a computer.

The system 100 also includes a server computer 101 coupled to a network 120 via a connection 140. The server computer 101 may operate to communicate with a number of devices over one or more networks such as the network 120. The network 120 may be a wired or wireless network, or a combination of wired and/or wireless networks. The devices 195 and 199 can communicate with the network 120 via connections 121 and 123 respectively.

The connections 121, 123 and 140 may each be a wired, wireless, or a combination of wired and wireless connection. For example, the connections 121, 123 and 140 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

FIG. 1B forms a schematic block diagram of the electronic device 195 upon which the methods described may be practiced. The device 199 operates in a similar manner to the device 195. The server computer 101 typically operates in a similar manner to the device 195. However, in comparison to the server computer 101 and the computer 199, processing resources of the device 195 are typically limited.

As seen in FIG. 1B, the electronic device 195 comprises an embedded controller 102. Accordingly, the electronic device 195 may be referred to as an “embedded device.” In the present example, the controller 102 has a processing unit (or processor) 105 which is bi-directionally coupled to an internal storage module 109. The storage module 109 may be formed from non-volatile semiconductor read only memory (ROM) and semiconductor random access memory (RAM, not shown). The RAM may be volatile, non-volatile or a combination of volatile and non-volatile memory.

The electronic device 195 includes a display controller 107, which is connected to a video display 114, such as a liquid crystal display (LCD) panel or the like. The display controller 107 is configured for displaying graphical or bitmap images on the video display 114 in accordance with instructions received from the embedded controller 102, to which the display controller 107 is connected.

The electronic device 195 also includes user input devices 113 which are typically formed by keys, a keypad or like controls. In implementations where the device 195 is a mobile communications device, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

The electronic device 195 also has a communications interface 108 to permit coupling of the device 195 to the server computer 101 via the communications network 120 and the connection 121.

The electronic device 195 in the example of FIG. 1B also includes geo-location hardware 115 that permits the device 195 to determine a current geographic position. The server computer 101 and the device 199 do not need to determine geographic location in the arrangements described.

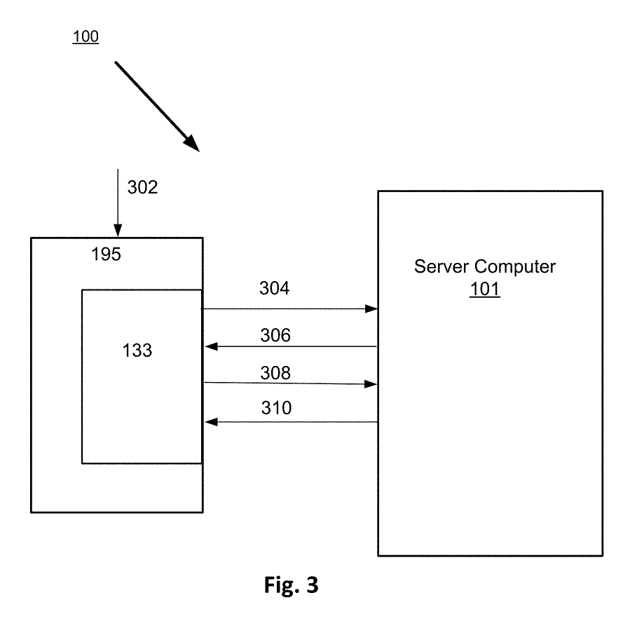

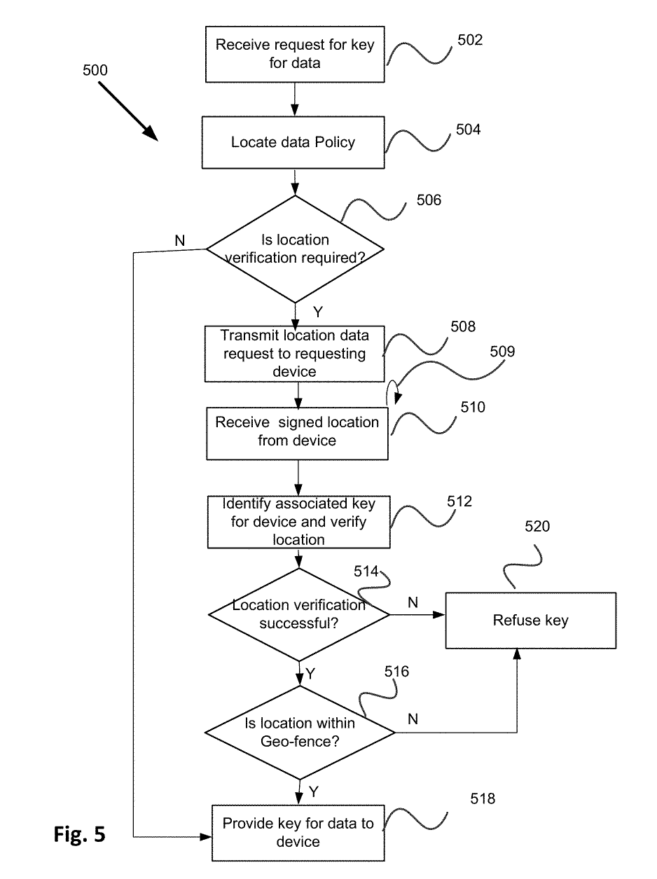

The methods described hereinafter may be implemented using the embedded controller 102, where the processes of FIG. 3 may be implemented as one or more software application programs 133 executable within the embedded controller 102. Similarly, the method of FIG. 5 may be implemented as one or more software application programs executable on a processor of the server computer 101.

The application program 133 is typically pre-installed and stored in the storage 109 upon subscription by the person 190 to a key retrieval service provided via the server computer 101. However, in some instances, the application program 133 may be supplied via a computer readable medium to the device 195.

The server computer 101 is typically operated by a provider of a distributed key service that provides keys, as discussed above. The server computer 101 includes a processor 145 (FIG. 1B) that operates in a similar manner to the processor 105. The server computer 101 also includes a memory 155 including an application 160 executable on the processor 145 to perform the methods described herein. The memory 155 and the application 160 may be of similar form to the memory 109 and the application 133.

The persons 190 and 197 are registered users of the service of the server computer 101 and each has a corresponding account registered with the service and stored on the server 101. The person 197 has registered the device 199 in their account on the server computer 101. The person 190 has registered the device 195 in association with their account on the server computer 101.

In the arrangements described, the person 197 encrypts a data object using the device 199. The person 197 operates the device 199 to instruct the server 101 that the person 190 is to be allowed access to the encrypted data object. A key by which the person 190 can access the object is generated and stored by the server computer 101. In some implementations, the person 197 encrypts data for personal use. In such implementations, a key is generated that can only be accessed by the person 197. The arrangements described hereafter relate to the person 190 accessing the encrypted data, and are described generally in relation to the device 195 only for brevity.

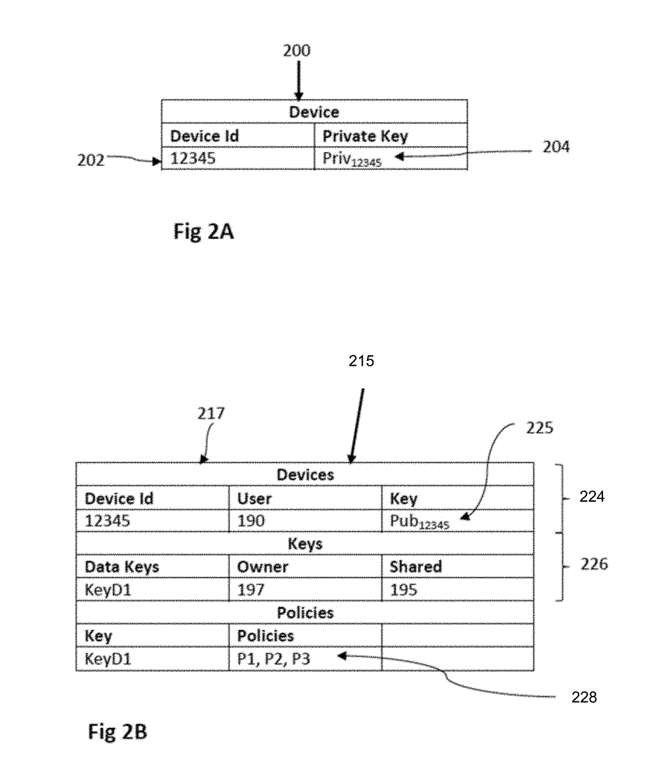

As the person 190 is a registered user of the server computer 101, and has registered the device 195, the application 133 is stored on the device 195. The application 133 executes to generate a device identifier 202 for the device 195 and a public-private key pair 204, 225 (FIGS. 2A, 2B) by execution of the application 133. The device identifier 202 may be derived from an identifier already belonging to the device 195. FIG. 2A shows resultant data 200 stored in the internal storage 109 of the device 195. The private key 204 is stored on the device 195 only and is not made publicly available. The private key 204 may be encrypted before being stored on the device 195. The data 200 includes the device identifier 202 and at least the private key 204.

The server computer 101 stores data 215 in a database arrangement, as shown in FIG. 2B. The data 215 includes an entry 224 indicating an associated registered device (the device 195) and a corresponding public key 225. The public key 225 corresponds to the private key 204 of FIG. 2A. The data 215 further includes an entry 226 for a data key (“KeyD1”) created for accessing the encrypted data D1. The person 190 requires access to the data key “KeyD1” to access the encrypted data object D1.

The encrypted data D1 is typically not stored by server computer 101 providing the key service. The encrypted data D1 is normally stored by user 197 and is made available to other users the person 197 has shared the data with (such as the person 190).

The encrypted data D1 may for example be generated according to Equation (1) below.

D1=Encrypt(keyD1,d) Equation (1)

In Equation (1), Encrypt represents an encryption function and d represents the original unencrypted data.

As seen in entry 228, data key D1 stored with the data 215 has one or more associated policies. One of the policies of the entry 228 (“P1”) relates to the geographic location from which a request for the public data key KeyD1 is allowed.

### Operation of Distributed Key Service

The person 190 receives the encrypted data object (D1) at the device 195 and wants to access the data.

FIG. 3 shows operation of the system 100 of providing regulated key retrieval by which the person 190 gains access to the data object. Communications between the devices 195 and 101 in FIG. 3 are via the network 120 and connections 121 and 140. However, for simplicity of description, the network 120 and connections 121 and 140 are omitted from FIG. 3.

The user operates the inputs 113, as indicated by an arrow 302 in FIG. 3 to manipulate the GUI operating on the device 195. The operations instruct the device 195 to open the encrypted data object D1. The application 133 executes to open to data object. The application 133 contacts the server 101, requesting the corresponding key, “KeyD1”.

The device 195 transmits a request to access the data key KeyD1 associated with the encrypted data object, as indicated by an arrow 304. The server computer 101 receives the request 304 and reviews policies associated with the key KeyD1, which include geographic origin requirements due to association with the policy P1. The server computer 101 executes an application and requests geographic location data from the device 195, as indicated by an arrow 306.

The device 195 receives the request for geographic location data 306. The device 195 determines a current location. The device 195 signs the location using the private key 204 of the device 195, creating a signed location L. Signing the location using the private key 204 effectively operates to encrypt the location. The signed location L may be created using

L=Sign(loc,Priv₁₂₃₄₅) Equation (2)

In Equation (2), Sign is a signature function and loc is the geographic location of the device 195.

The application 133 executes to transmit the signed location L to the server computer 101, as indicated by an arrow 308.

The server computer 101 receives the signed location L of the transmission 308 and uses the public key of the device (entry 258 associated with the device 195) to verify the location data loc, for example according to Equation (3). In verifying the location L, the server computer effectively operates to decrypt the signed location data L.

loc=Verify(L,P₁₂₃₄₅) Equation (3)

In Equation (3), Verify relates to a signature function used by the server computer 101.

Policy P1 of the entry 228 includes geographic requirements. Geographic requirements are typically implemented as a geo-fence. A geo-fence relates to a polygon described by a number of vertices being geographic locations. The polygon effectively forms a set of boundaries within which the origin of the request must lie to be valid. For example, the geo-fence may describe the boundaries of mainland Australia—access to the key KeyD1 may only be granted to requests made from mainland Australia.

The server 101 compares the signature of the geographic location against the device identifier. The server 101 compares the geographic location and provides a reply, indicated by an arrow 310. If the geographic requirements are met—the device 195 made the request within Australia—the reply 310 includes the key associated with the data. If the requirements are not met—the device 195 is understood to have made the request outside Australia, the reply 310 includes an error message, denying access to the key KeyD1.

The communications between the device 195 and the server computer 101 are normally made using secure standards such as Transport Layer Security (TLS) or Secure Sockets Layer (SSL) for increased security of data.

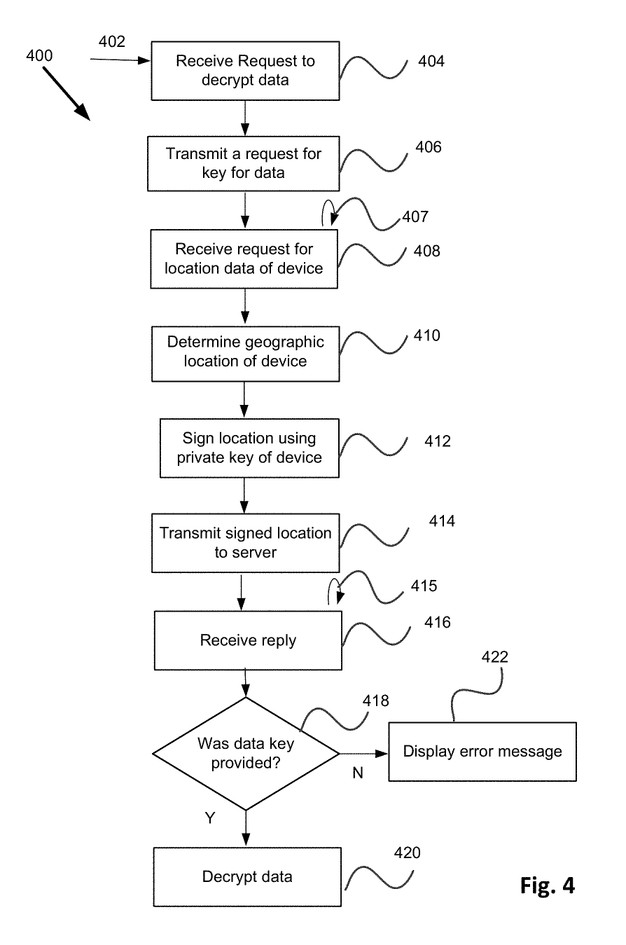

FIG. 4 shows a method 400 as executed by the application 133 on the device 195. The method 400 shows operations on the side of the device 195 for operation of the system 100 described in relation to FIG. 3.

The method 400 starts at a step 404 when the person 190 operates the inputs 113 to instruct the device 195 to open the encrypted data, as shown by an input 402. The application 133 receives the input instruction 402 to decrypt the data at step 404.

The method 400 progresses to a step 406. At step 406, the application 133 causes transmission of a request for the key KeyD1 for the data to the server computer 101, as per arrow 304 in FIG. 3. The application 133 executes to wait (407) after transmitting the request at step 406.

The method 400 progresses to step 408, where the device 195 receives the request for location data from the server computer 101 (as per 306 of FIG. 3). The request may be stored in the memory 109 at step 408.

The method 400 continues to a step 410. At step 410, the device 195 determines a current geographic location. The geographic location can be determined in a traditional manner, for example via a GPS chip installed in the device 195, or via strength signals received from communications networks, for example using base-station triangulation. The determined location data loc includes at least geographic coordinates, or data that can be converted to geographic coordinates, of the device 195. In some implementations, other location information may be included in the data loc, such as an identity of one or more base stations from which the coordinates were determined, and timestamps of data received from the base stations.

Upon determining the current geographic location, the method 400 continues to a step 412. In step 412, the determined location is signed using the private key 204 and Equation (2).

The method 400 continues to step 414. At step 414, the signed location is transmitted to the server computer 101 (as per transmission 308 of FIG. 3). Upon transmitting the signed location, the application 133 waits (415) to receive a reply from the server computer 101.

The method 400 progresses to step 416 and the device 195 receives the reply. Data included in the reply is stored at least temporarily in the memory 109.

The method 400 proceeds to a check step 418. At step 418, the application 133 executes to check if the reply of step 416 included the key required to decrypt the data. If the key KeyD1 was provided (“Y” at step 418), the method proceeds to step 420. In step 420, the application 133 decrypts the data using the key KeyD1 received in step 416.

Returning to step 418, if the key was not provided (“N” at step 418), the method proceeds to step 422. In step 422, an error message is displayed to the user via the display 114 to indicate that access to public key has been refused.

FIG. 5 shows a method 500 as executed by the application 160 on the server computer 101. The method 500 shows operations on the side of the server computer 101 for operation of the system 100 described in relation to FIG. 3.

The method 500 begins at a step 502. The server computer 101 receives the request for the key (KeyD1) for the data from the device 195 at step 502. Such relates to the arrow 304 of FIG. 3.

The method 500 progresses to a step 504. In the step 504, the server computer 101 locates the policy (P1) associated with the data key KeyD1. For example, such may relate to the policy P1 in the entry 228 of FIG. 2B. The method 500 continues to a step 506. The server computer determines if location verification is required by the policy P1 associated with the key KeyD1 at step 506. If location verification is not required (“N”) at step 506, the method 500 continues to step 508.

If location data is required at step 506 (“Y” at step 506), the method 500 proceeds to step 508. The server computer 101 prepares and transmits a request for location data to the device 195 at step 508. Such corresponds to the arrow 306 of FIG. 3. Upon completing the step 508, the server computer 101 awaits (509) a reply from the device 195.

The method 500 proceeds to step 510 upon receiving the signed location L from the device 195. The signed location L is stored at least temporarily on the server computer 101. The method 500 continues to a step 512. The associated public key of the entry 254 for the device 195 is determined from the database structure at step 512. The signed location L is verified according to Equation (3).

The method 500 continues to a check step 514. At step 514, execution of the application 160 by the server computer 101 determines whether the verification of step 512 was successful. Determining whether the verification was successful involves determining if the verification resulted in a correctly formatted geographic location. The device 195 is the sole source of the private key Priv₁₂₃₄₅. If the verification is successful using the public key associated with the device 195, confidence that the request for the key KeyD1 actually originated (the request was signed) at the device 195 is improved in comparison to receiving location data unsigned.

If the verification was not successful the method 500 continues to step 520. Otherwise, the method 500 continues to a check step 516. At step 516, the server computer 101 determines if the verified location satisfies geographic origin requirements by lying within the associated geo-fence.

In other implementations (not shown), the verified data loc contains information in addition to or alternatively to geographic coordinates (for example base station identities and timestamps). In such implementations, at step 516 the server 101 can also assess the validity of the location of the device and the likelihood that the devices position is being spoofed. Such assessment can for example be made by verifying that the base station identity corresponds to the coordinates, determining latency of the received data using timestamps. In such implementations, the server 101 can assess a risk of the location information being correct, for example by determining whether any discrepancy between the coordinates and the other information is with a predetermined threshold. If the risk is over the predetermined threshold, reliability of the location information is in doubt and the server 101 will not issue the key. Such arrangements effectively estimate a risk of whether the location information loc has been tampered with.

If the verified location is determined to be within the associated geo-fence, the method 500 continues to step 518. At step 518, the corresponding key KeyD1 required to decrypt the data is transmitted to the device 195.

If the verified location is determined not to be within the associated geo-fence, the method 500 continues from step 516 to step 520. An error message 520 is generated and transmitted to the device 195 at step 520. The transmission at each of steps 518 and 520 relate to the reply indicated by the arrow 310 of FIG. 3.

### INDUSTRIAL APPLICABILITY

The arrangements described are applicable to the computer and data processing industries and particularly for the data encryption industries. The arrangements described have an effect of increasing confidence that the geographic location provided and the device providing the geographic location are valid. As only the device 195 has access to the key Priv12345, security of the request for the key is improved, as this can only have originated from a known device. Further, by controlling access to cryptography keys according to location, complexity regarding geographic location for data is avoided. By restricting access to the key, another layer of security is provided in relation to the encrypted data.

For example, a businessman travelling to country A may not realise that due to regulatory compliance in country A they should not access sensitive data. However, if access to the relevant key is only granted for requests made within country B, the key will not be provided in response to the request.

The public and private keys associated with the device 195 are not relevant to cryptography of data objects themselves. Rather, the keys associated with the device 195 provide a measure of confidence that the correct device has made the request to access data. Further, transmission of the correct location data which is not signed, or which is incorrectly signed, will result in refusal of a request to access data.

From an enterprise perspective, a Swiss global investment bank could sign up to the service provided by the server 101 and choose for example, Swiss, Singapore, US and Australian key services. The data from all those regions can be locally controlled. Similarly US data cannot be opened in Switzerland and vice versa. In addition to corporate governance compliance, such can legitimately help solve the issues compounding with the collapse of the European ‘Safe Harbour’ laws for data between the US and Europe.

The arrangements described typically form part of an overall data security system. For example, the arrangements described may be implemented in relation to only one policy requirement associated with encrypted data or a data key, and may be integrated into systems including further policies.

The foregoing describes only some embodiments of the present invention, and modifications and/or changes can be made thereto without departing from the scope and spirit of the invention, the embodiments being illustrative and not restrictive.

1. A method for key retrieval comprising:
receiving, from a device, a request to access a key associated with an encrypted data object;
identifying at least one policy associated with the key, the policy including requirements for a geographic origin of the request;
receiving a signed location of the device, the location being signed using a private key associated with the device;
verifying the signed location using a public key associated with the device;
determining if the verified location satisfies the requirements for a geographic origin; and
if the location satisfies the requirements for a geographic origin, providing the key to the device.

2. A server computer, comprising:
a processor;
a memory coupled to the processor, the memory storing an application configured to perform a method for key distribution comprising:
receiving, from a device via a network, a request to access a key associated with an encrypted data object;
identifying at least one policy associated with the key, the policy including requirements for a geographic origin of the request;
receiving a signed location of the device from the device via the network, the location being signed using a private key associated with the device;
verifying the signed location using a public key associated with the device;
determining if the verified location satisfies the requirements for a geographic origin; and
if the location satisfies the requirements for a geographic origin, providing the key to the device via the network.

3. An electronic device, comprising:
a processor;
one or more user inputs;
a display; and
a memory coupled to the processor, the memory storing a private key associated with the electronic device and an application, the application comprising instructions executable on the processor to perform a method of key distribution comprising:
receiving, via the user inputs, instructions to request to access a key associated with an encrypted data object;
transmitting a request to a server computer via a network to access the key;
determining a geographic location of the electronic device;
signing the determined geographic location using the private key;
transmitting the signed geographic location to the server computer;
receiving a reply from the server computer via the network; and
if the received reply includes the requested key; decrypting the data object using the key, otherwise providing an error message on the display.

4. An application executable on a processor of an electronic device, the application comprising instructions to case the electronic device to at least:
receiving, via user inputs of the electronic device, instructions to request to access a key associated with an encrypted data object;
transmit a request to a server computer via a network to access the key;
determine a geographic location of the personal computing device;
sign the determined geographic location using the private key;
transmit the signed geographic location to the server computer;
receive a reply from the server computer via the network; and
if the received reply includes the requested key; decrypt the data object using the key, otherwise display an error message.
